(19) United States
(12) Patent Application Publication
(10) Pub. No.: US 2010/0268855 A1
(43) Pub. Date: Oct. 21, 2010

(54) ETHERNET PORT ON A CONTROLLER FOR MANAGEMENT OF DIRECT-ATTACHED STORAGE SUBSYSTEMS FROM A MANAGEMENT CONSOLE

(76) Inventors: Sunny Koul, Bangalore (IN); Ranjan Kumar, Bokaro Steel City (IN); Gururaj Shivashankar Morabad, Savadatti (IN)

Correspondence Address: GLOBAL IP SERVICES, PLLC, 10 CRESTWOOD LANE, NASHUA, NH, 03062, US

(21) Appl. No.: 12/424,550

(22) Filed: Apr. 16, 2009

(51) Int. Cl. G06F 13/12; G06F 15/16; G06F 12/08

(52) U.S. Cl. 710/74; 709/230; 711/114; 711/E12.019

(57) ABSTRACT

A system and device for central bios level management of direct-attached storage subsystems is disclosed. A system includes a plurality of DAS subsystems, with each DAS subsystem including a host bus adapter (HBA) having a local area network (LAN) port and a LAN communication module for providing a LAN communication based on an internet protocol (IP) address of the HBA. The system further includes a management console coupled to the plurality of DAS subsystems using the LAN port for managing the plurality of DAS subsystems by directly communicating with the HBA of said each DAS subsystem using the IP address of the HBA. The system also includes a network switch for controlling data traffic between the plurality of DAS subsystems and the management console.

### FIELD OF TECHNOLOGY

Embodiments of the present invention relate to the field of electronics. More particularly, embodiments of the present invention relate to direct-attached storage (DAS) subsystems.

### BACKGROUND

A direct-attached storage (DAS) subsystem refers to a storage subsystem directly attached to a server or a workstation, without a storage network in between. In a DAS infrastructure, where a plurality of DAS subsystems are separately managed, manageability of the DAS subsystems may be operating system (OS) dependent and require more manpower. For each DAS subsystem, a host bus adapter (HBA) may be dedicated for controlling a storage device of the DAS subsystem. In order to manage each DAS subsystem, an administrator may rely on an OS utility to configure the HBA. As a result, the administrator may have to separately log-on to each of the DAS subsystems for configuring the HBA, thus causing administrative difficulties and wastage of time.

Furthermore, the HBA forwards debugger logs, which list out results of testing and debugging of the HBA, through a serial port of the HBA. The debugger logs may be used by the administrator to control and collect vital information associated with the HBA. Currently, the serial port of the HBA is used to connect to a separate system (e.g., a dedicated printer, a hyper terminal, etc.) for storing and/or accessing the debugger logs. For example, the serial port of the HBA may be a 4 pin serial connector which is connected to the separate system using a serial debugger or serial null modem cable. Thus, significant resources may be needed to access the debugger logs if the size of the DAS subsystems happens to be large.

### SUMMARY

This summary is provided to comply with 37 C.F.R. §1.73, requiring a summary of the invention briefly indicating the nature and substance of the invention. It is submitted with the understanding that it will not be used to interpret or limit the scope or meaning of the claims.

A system and device for managing direct-attached storage (DAS) subsystems from a management console is disclosed. In one aspect, a system for managing a plurality of DAS subsystems from a management console includes a plurality of DAS subsystems. Each DAS subsystem includes a host bus adapter (HBA) having a local area network (LAN) port and a LAN communication module for providing a LAN communication based on an internet protocol (IP) address of the HBA.

The system further includes a management console coupled to the plurality of DAS subsystems using the LAN port for managing the plurality of DAS subsystems by directly communicating with the HBA of said each DAS subsystem using the IP address of the HBA. The system also includes a network switch for controlling data traffic between the plurality of DAS subsystems and the management console.

In another aspect, a HBA for a DAS subsystem includes a HBA port for interfacing with a storage device of the DAS subsystem and a LAN port for interfacing with a management console associated with the DAS subsystem. The HBA further includes a LAN communication module for communicating with the management console based on an IP address of the HBA and a processor for executing a set of instructions associated with the LAN communication module.

Other features of the present embodiments will be apparent from the accompanying drawings and from the detailed description that follows.

### BRIEF DESCRIPTION OF THE DRAWINGS

Various preferred embodiments are described herein with reference to the drawings, wherein:

FIG. 1 illustrates a system diagram of an exemplary system for managing a plurality of direct-attached storage (DAS) subsystems from a management console, according to one embodiment;

FIG. 2 illustrates an exemplary host bus adapter (HBA) for the DAS subsystem of FIG. 1, according to one embodiment;

FIG. 3 illustrates a system diagram of another exemplary system for managing a plurality of DAS subsystems from a management console, according to one embodiment; and

FIG. 4 illustrates a screen view of an exemplary user interface for the management console of FIG. 1, according to one embodiment.

The drawings described herein are for illustration purposes only and are not intended to limit the scope of the present disclosure in any way.

### DETAILED DESCRIPTION

A system and device for managing direct-attached storage (DAS) subsystems from a management console is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

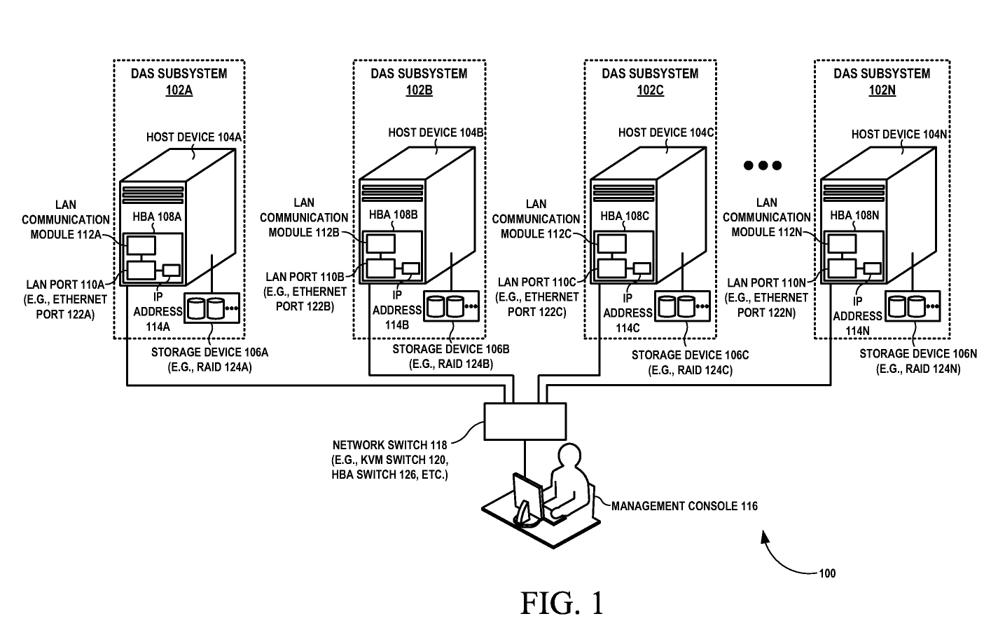

FIG. 1 illustrates a system diagram 100 of an exemplary system for managing a plurality of DAS subsystems 102A-N from a management console 116, according to one embodiment. As illustrated, the plurality of DAS subsystems 102A-N is coupled to the management console 116 via a network switch 118 (e.g., a keyboard, video monitor and mouse (KVM) switch 120, a HBA switch 126, etc.).

The plurality of DAS subsystems 102A-N includes host devices 104A-N and storage devices 106A-N (e.g., redundant array of independent disks (RAID) 124A-N) coupled to the host devices 104A-N. The host devices 104A-N include host bus adapters (HBAs) 108A-N having local area network (LAN) ports 110A-N (e.g., Ethernet ports 122A-N) and LAN communication modules 112A-N. Further, each of the HBAs 108A-N is associated with a defined internet protocol (IP) address (e.g., IP addresses 114A-N). It can be noted that, the management console 116 is coupled to the plurality of DAS subsystems 102A-N using the respective LAN ports 112A-N.

In one embodiment, the LAN ports 112A-N and the LAN communication modules 112A-N provide a LAN communication between the management console 116 and the plurality of DAS subsystems 102A-N based on the IP addresses 114A-N of the HBAs 108A-N. In this embodiment, the management console 116 manages the plurality of DAS subsystems 102A-N by directly communicating with the HBAs 108A-N of each of the plurality of DAS subsystems 102A-N using the IP addresses 114A-N of the HBAs 108A-N.

In one exemplary implementation, each of the HBAs108A-N is pinged by the management console 116 by addressing the IP addresses 114A-N of the HBAs 108A-N. The management console 116 pings each of the HBAs 108A-N to determine an operational state of each of the HBAs 108A-N. Further, in accordance with above described embodiments, the network switch 118 controls data traffic between the plurality of DAS subsystems 102A-N and the management console 116.

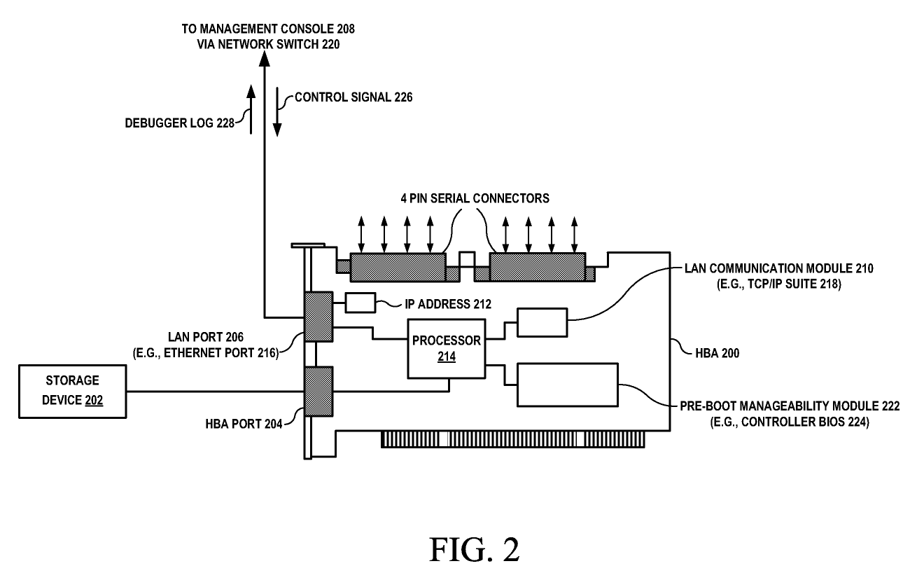

FIG. 2 illustrates an exemplary HBA 200 for the DAS subsystem 102 of FIG. 1, according to one embodiment. It is appreciated that, the HBA 200 is an exemplary embodiment of the HBAs 108A-N of FIG. 1. The HBA 200 includes a HBA port 204, a LAN port 206, a LAN communication module 210, a processor 214, and a pre-boot manageability module 222. As illustrated in FIG. 2, the HBA port 204 interfaces with a storage device 202 of the DAS subsystem 102. The LAN port 206 (e.g., an Ethernet port 216) interfaces with a management console 208 associated with the DAS subsystem 102 via a network switch 220.

In one embodiment, the LAN port 206 is operable for providing an access to the pre-boot manageability module 222 (e.g., a controller basic input/output system (BIOS) 224) of the HBA 200 from the management console 208. In another embodiment, the LAN port 206 is operable for forwarding a debugger log 228 generated by the HBA 200 to the management console 208. In these embodiments, the management console 208 manages the HBA 200 via a control signal 226.

Further, in accordance with the above described embodiments, the LAN communication module 210 communicates with the management console 208 based on an IP address 212 of the HBA 200. In one embodiment, the LAN communication module 210 is operable for supporting a transfer control protocol/internet protocol (TCP/IP) suite 218. Moreover, the processor 214 executes a set of instructions associated with the LAN communication module 210.

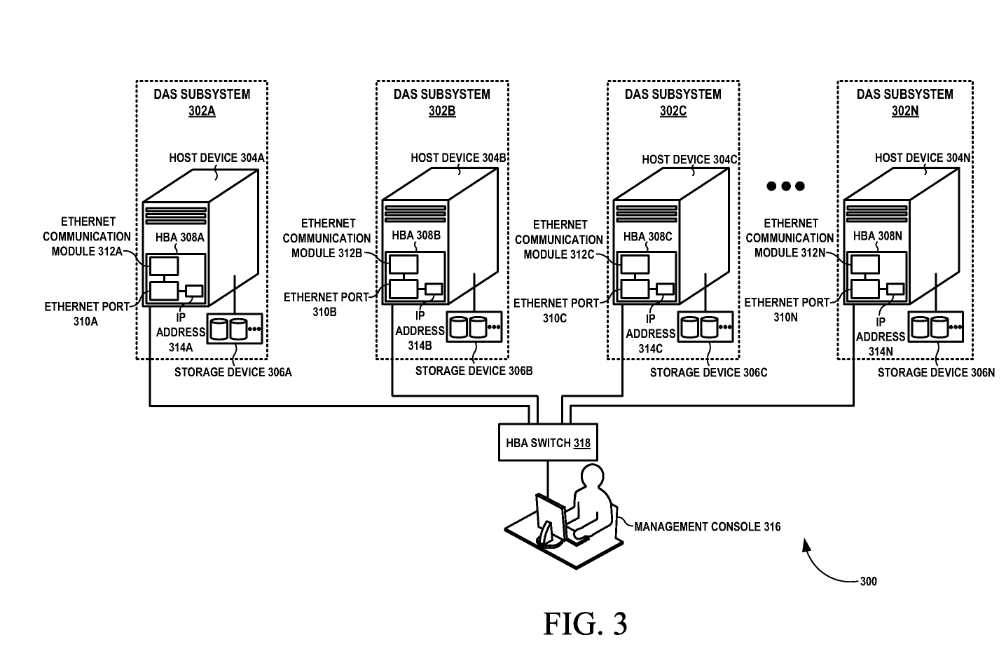

FIG. 3 illustrates a system diagram 300 of another exemplary system for managing the plurality of DAS subsystems 302A-N from a management console 316, according to one embodiment. As illustrated, the plurality of DAS subsystems 302A-N is coupled to the management console 316 via a HBA switch 318. The plurality of DAS subsystems 302A-N includes host devices 304A-N and storage devices 306A-N coupled to the host devices 304A-N. The host devices 304A-N include HBAs 308A-N with Ethernet ports 310A-N and Ethernet communication modules 312A-N.

In one embodiment, the Ethernet ports 310A-N and the Ethernet communication modules 312A-N provide an Ethernet communication based on IP addresses 314A-N of the HBAs 308A-N. In this embodiment, the management console 316 coupled to the plurality of DAS subsystems 302A-N manages the plurality of DAS subsystems 302A-N by addressing the IP addresses 314A-N of the HBAs 308A-N. In accordance with the above described embodiments, the HBA switch 318 controls the plurality of DAS subsystems 302A-N from the management console 316.

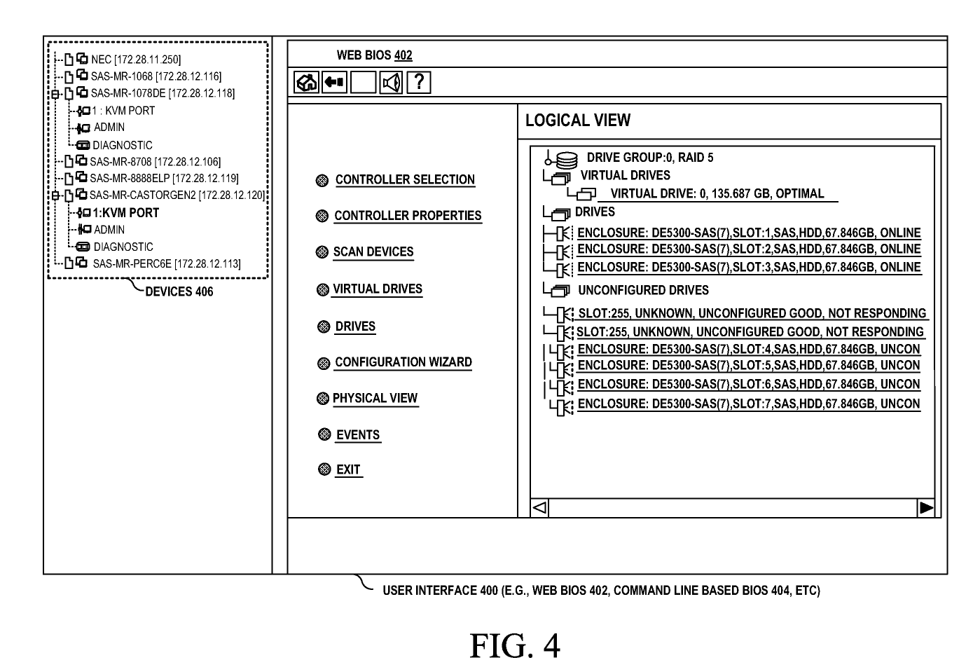

FIG. 4 illustrates a screen view of an exemplary user interface 400 for the management console 116 of FIG. 1, according to one embodiment. In one embodiment, the management console 116 is operable for displaying the user interface 400 for configuring the plurality of DAS subsystems 102A-N. In one example embodiment, the user interface 400 may include a graphical user interface (GUI) based web BIOS 402. In another example embodiment, the user interface 400 may include a command line based BIOS 404. For example, the web BIOS 402 and command line based BIOS 404 are pre-boot utilities.

As illustrated in FIG. 4, the user interface 400 shows the web BIOS 402 and a devices block 406 where the DAS subsystems 102A-N are listed. It can be seen in the devices block 406 that, the DAS subsystems 102A-N are listed by means of respective HBAs 108A-N (e.g., SAS-MR-1078DE, SAS-MR-CASTRGEN2) with their IP addresses. A user (e.g., administrator) can access each of the HBAs 108A-N by selecting a link associated with each of the HBAs 108A-N in the devices block 406. For example, the HBA switch/KVM switch enables accessing of the HBAs 108A-N via the link in the web BIOS 402. In one embodiment, the user interface 400 allows the user to access the selected HBA upon a user authentication. In this embodiment, the user may have complete access to HBA BIOS and debugger logs of the selected HBA.

In the example embodiment illustrated in the FIG. 4, the HBA BIOS is displayed upon selecting ‘KVM port’ associated with the selected HBA from the devices block 406. It is appreciated that, the user can manage RAID volumes and functionality of the selected HBA using the web BIOS 402. Further, selecting a ‘diagnostic’ link from the devices block 406 may enable the user to access the debugger logs thrown by firmware of the selected HBA. Thus, the user can have a complete control of the selected HBA by accessing the debugger logs as well as the web BIOS 402.

The above-described system allows the user to configure and manage HBAs of DAS subsystems from a management console using LAN ports of the HBAs. In one embodiment, the above-described system can configure the HBAs of the DAS subsystems directly from a network without even having to boot the DAS subsystems. Since all the HBAs in a DAS environment are centrally managed from the management console, an operational state of the HBA can be determined by pinging the HBA and getting a response. The above-described system uses same Ethernet cable for accessing firmware logs, thereby eliminating the need of setting up different systems for accessing debugger logs. Further, by using the above-described system, manpower required for testing and debugging a large number of DAS subsystems can be reduced as the DAS subsystem is managed from the centrally located management console.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., complementary metal-oxide-semiconductor (CMOS) based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry (ASIC)).

What is claimed is:

1. A system for managing a plurality of direct-attached storage (DAS) subsystems from a management console, comprising:
a plurality of direct-attached storage subsystems, with each direct-attached storage subsystem comprising:
a host bus adapter (HBA) having a local area network (LAN) port and a local area network communication module for providing a local area network communication based on an internet protocol (IP) address of the host bus adapter; and
a management console coupled to the plurality of direct-attached storage subsystems using the local area network port for managing the plurality of direct-attached storage subsystems by directly communicating with the host bus adapter of said each direct-attached storage subsystem using the internet protocol address of the host bus adapter.

2. The system of claim 1, further comprising a network switch for controlling data traffic between the plurality of direct-attached storage subsystems and the management console.

3. The system of claim 2, wherein the network switch comprises a keyboard, video monitor, and mouse (KVM) switch.

4. The system of claim 1, wherein the local area network port comprises an Ethernet port.

5. The system of claim 1, wherein the local area network port is operable for providing an access to a pre-boot manageability module of the host bus adapter from the management console.

6. The system of claim 5, wherein the pre-boot manageability module comprises a controller basic input/output system (BIOS) of the host bus adapter.

7. The system of claim 6, wherein the management console is operable for displaying a user interface for configuring said each direct-attached storage subsystem.

8. The system of claim 7, wherein the user interface comprises a graphical user interface (GUI) based web basic input/output system.

9. The system of claim 7, wherein the user interface comprises a command line based basic input/output system.

10. The system of claim 1, wherein the management console pings the host bus adapter by addressing the internet protocol address of the host bus adapter to determine an operational state of the host bus adapter.

11. The system of claim 1, wherein the local area network port is operable for forwarding a debugger log generated by the host bus adapter to the management console.

12. The system of claim 1, wherein said each direct-attached storage subsystem comprises a host device of said each host bus adapter and a storage device.

13. The system of claim 12, wherein the storage device comprises a redundant array of independent disks (RAID).

14. A host bus adapter for a direct-attached storage subsystem, comprising:
a host bus adapter port for interfacing with a storage device of the direct-attached storage subsystem;
a local area network port for interfacing with a management console associated with the direct-attached storage subsystem;
a local area network communication module for communicating with the management console based on an internet protocol address of the host bus adapter; and
a processor for executing a set of instructions associated with the local area network communication module.

15. The host bus adapter of claim 14, wherein the local area network port comprises an Ethernet port.

16. The host bus adapter of claim 14, wherein the local area network communication module is operable for supporting a transport control protocol/internet protocol (TCP/IP) suite.

17. The host bus adapter of claim 14, wherein the interfacing with the management console is performed via a network switch.

18. The host bus adapter of claim 14, wherein the local area network port is operable for providing an access to a pre-boot manageability module of the host bus adapter from the management console.

19. The host bus adapter of claim 18, wherein the pre-boot manageability module comprises a controller basic input/output system of the host bus adapter.

20. A system for managing a plurality of direct-attached storage subsystems from a management console, comprising:
a plurality of direct-attached storage subsystems, with each direct-attached storage subsystem comprising:
a host bus adapter having an Ethernet port and an Ethernet communication module for providing an Ethernet communication based on an internet protocol address of the host bus adapter;
a management console coupled to the plurality of direct-attached storage subsystems for managing the plurality of direct-attached storage subsystems by addressing the internet protocol address of the host bus adapter of said each direct-attached storage subsystem; and
a host bus adapter switch for controlling the plurality of direct-attached storage subsystems from the management console.
